(19) United States
(12) Patent Application Publication
(10) Pub. No.: US 2026/0174295 A1
(43) Pub. Date: Jun. 25, 2026

(54) MAGNETIC VACUUM BAG FOR VACUUM CLEANER ASSEMBLY

(71) Applicant: Zenith Holding, LLC, Fort Lauderdale, FL (US)

(72) Inventors: Mark D BOSSES, Boca Raton, FL (US); Jacob B BOSSES, Boca Raton, FL (US)

(21) Appl. No.: 19/097,797

(22) Filed: Apr. 1, 2025

Related U.S. Application Data
(60) Provisional application No. 63/738,723, filed on Dec. 24, 2024.

(51) Int. Cl. A47L 9/14; A47L 5/28; H01F 7/02

(52) U.S. Cl. CPC A47L 9/1436; A47L 5/28; H01F 7/0263

(57) ABSTRACT

A vacuum bag for a vacuum cleaner assembly includes a porous container and a collar. The collar is connected to the porous container. The collar includes an opening in communication with an interior of the porous container. A first retention member is connected to the collar. The first retention member is a magnet or a ferromagnetic material.

### CROSS REFERENCE TO RELATED APPLICATIONS

This application claims the benefit under 35 U.S.C. § 119(e) of U.S. Provisional Application No. 63/738,723, filed Dec. 24, 2024. The entire disclosure of U.S. Provisional Application No. 63/738,723 is hereby incorporated herein by reference.

### BACKGROUND

### Field of the Invention

The present disclosure generally relates to a vacuum bag for a vacuum cleaner assembly. More specifically, the present invention relates to a vacuum cleaner assembly including a vacuum bag having a first retention member and a vacuum cleaner body having a second retention member to facilitate securing the vacuum bag to the vacuum cleaner body.

### Background Information

Flow-through motor-style vacuum cleaners generally use an outer housing. The outer housing may be a partly porous bag because the air flow is being pushed into the vacuum bag. The outer housing is closeable, and typically uses a zipper or other suitable means to access a vacuum bag, or filter bag, housed therein for removal and replacement of the vacuum bag. The vacuum bag is typically a disposable bag that collects dust and dirt during operation of the vacuum cleaner, and is disposed of when full and replaced with a new bag.

Because the vacuum bag is disposable, it must be economical to produce. The vacuum bag should also be sufficiently durable to permit it to be installed and removed without damage. It should also provide a connecting and sealing structure for connecting the vacuum bag to the dirt-laden discharge of the vacuum cleaner that is easily installed.

Some conventional vacuum bags are friction fit to a nozzle of the vacuum cleaner. Tolerance variations result in improper fitting of the vacuum bag, resulting in inferior performance of the vacuum cleaner. Other conventional vacuum bags use a hinge system in which the vacuum bag slides into a frame, which is then pivoted to a closed position. The vacuum bag can be improperly connected to the frame and/or the frame is not properly closed, resulting in inferior performance of the vacuum cleaner.

### SUMMARY

A need exists for an improved vacuum bag and an improved connection between the vacuum bag and a vacuum cleaner body of a vacuum cleaner assembly.

In view of the state of the know technology and in accordance with a first aspect of the present disclosure, a vacuum bag for a vacuum cleaner assembly includes a porous container and a collar. The collar is connected to the porous container. The collar includes an opening in communication with an interior of the porous container. A first retention member is connected to the collar. The first retention member is a magnet or a ferromagnetic material.

Another aspect of the present disclosure is to provide a vacuum cleaner assembly including a vacuum cleaner body and a vacuum bag. The vacuum cleaner body includes an attachment assembly. The attachment assembly includes a first retention member connected thereto. The vacuum bag is configured to be removably connected to the attachment assembly. The vacuum bag includes a porous container, a collar, and a second retention member. The collar is connected to the porous container. The second retention member is connected to the collar. The second retention member is configured to contact the first retention member to secure the vacuum bag to the attachment assembly of the vacuum cleaner body. The first retention member is one of a magnet and a ferromagnetic material. The second retention member is one of a magnet and a ferromagnetic material. At least one of the first retention member and the second retention member is a magnet to magnetically attract the other of the first retention member and the second retention member to secure the vacuum bag to the attachment assembly of the vacuum cleaner body.

Also, other objects, features, aspects and advantages of the disclosed magnetic vacuum bag for a vacuum cleaner assembly will become apparent to those skilled in the art from the following detailed description, which, taken in conjunction with the annexed drawings, discloses several embodiments of a magnetic vacuum bag for a vacuum cleaner assembly.

### BRIEF DESCRIPTION OF THE DRAWINGS

Referring now to the attached drawings which form a part of this original disclosure:

FIG. 1 is a perspective view of an attachment assembly and a vacuum bag collar in accordance with an exemplary embodiment;

FIG. 2 is a perspective view of the attachment assembly and the vacuum bag collar of FIG. 2 in which the attachment assembly removably receives the vacuum bag collar;

FIG. 3 is another perspective view of the vacuum bag collar removably connected to the attachment assembly of FIG. 2;

FIG. 4 is a lower perspective view of the vacuum bag collar removably connected to the attachment assembly of FIGS. 2 and 3;

FIG. 5 is a perspective view of the vacuum bag collar removably connected to the attachment assembly of FIG. 2 in which the collar includes a vacuum bag and the attachment assembly is in the open position;

FIG. 6 is a perspective view of the vacuum bag collar removably connected to the attachment assembly of FIG. 2 in which the collar includes the vacuum bag and the attachment assembly is in the closed position;

FIG. 7 is a perspective view of a vacuum cleaner assembly including the vacuum bag of FIG. 5 connected thereto;

FIG. 8 is a perspective view of a vacuum bag collar in accordance with another exemplary embodiment;

FIG. 9 is a perspective view of the vacuum bag collar of FIG. 8 removably connected to an attachment assembly;

FIG. 10 is a perspective view of a vacuum bag including the vacuum bag collar of FIG. 8 prior to connecting the vacuum bag to an attachment assembly of a vacuum cleaner body; and

FIG. 11 is a perspective view of the vacuum bag including the vacuum bag collar of FIG. 8 connected to an attachment assembly of a vacuum cleaner body.

Throughout the drawing figures, like reference numerals will be understood to refer to like parts, components and structures.

### DETAILED DESCRIPTION OF EXEMPLARY EMBODIMENTS

Selected exemplary embodiments will now be explained with reference to the drawings. It will be apparent to those skilled in the art from this disclosure that the following descriptions of the exemplary embodiments are provided for illustration only and not for the purpose of limiting the invention as defined by the appended claims and their equivalents.

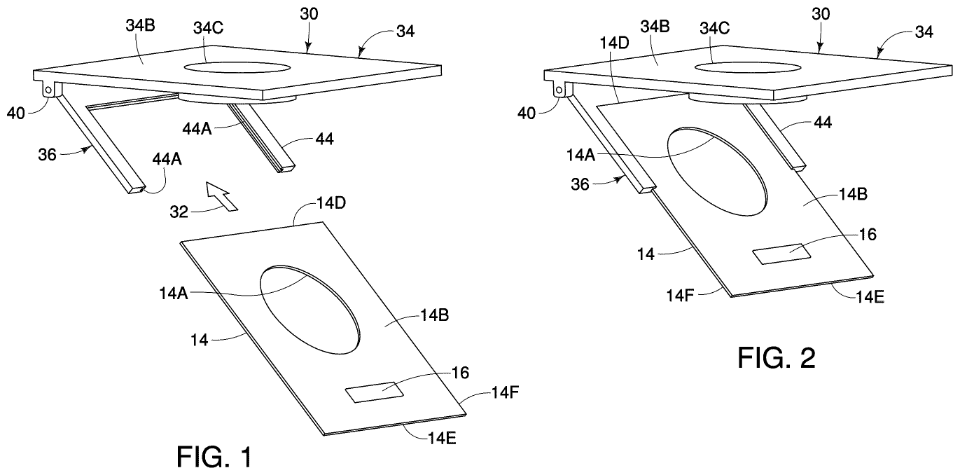

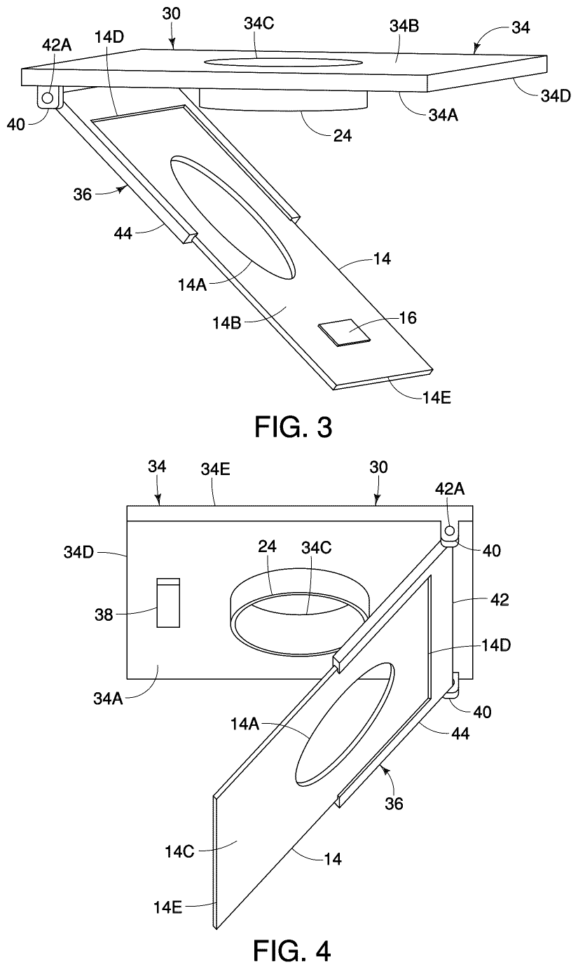

In accordance with exemplary embodiments of the present disclosure, a vacuum bag, or filter bag, 10 for a vacuum cleaner assembly 12 is shown in FIGS. 1-7. A collar 14 of the vacuum bag 10 includes at least one retention member 16 to facilitate securing the vacuum bag 10 the vacuum cleaner assembly 12.

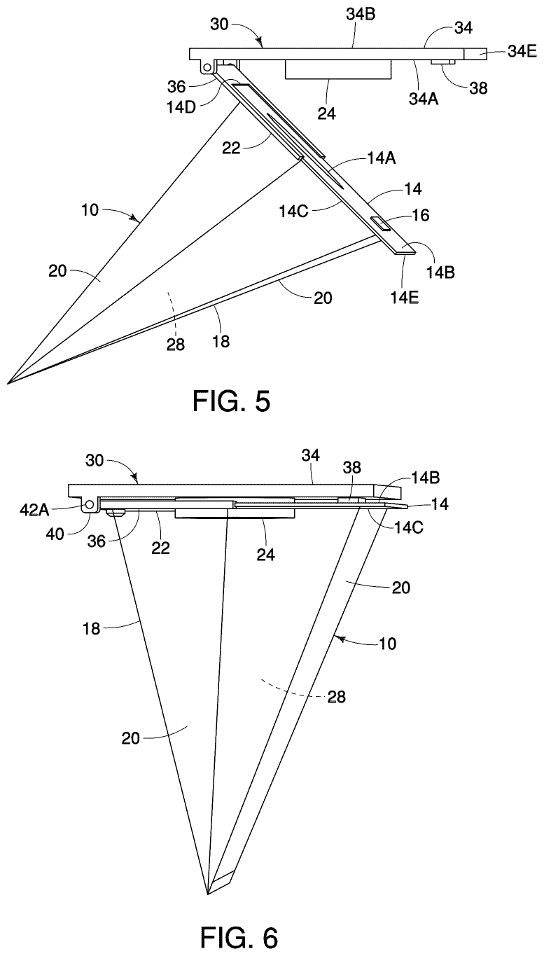

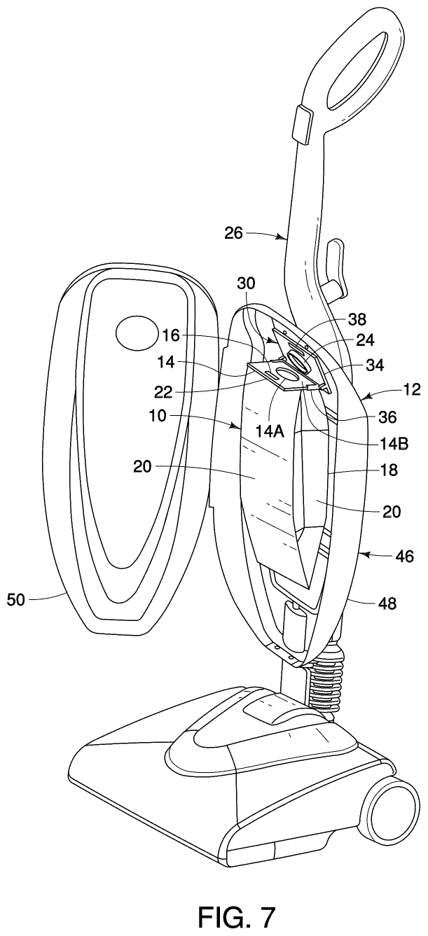

The vacuum bag 10, as shown in FIGS. 5 and 6, includes a container portion, or porous container, 18 having a plurality of side walls 20 and an upper wall 22. Although the container portion 18 is shown with a generally triangular shape in FIGS. 5 and 6, the container portion 18 can have any suitable shape. The container portion 18 is preferably made of a flexible and porous material, such as, for example, paper, non-woven material, woven material, or a combination thereof. An opening is formed in the upper wall 22 of the container portion 18 for intake of dust and debris drawn in through a vacuum nozzle 24 of the vacuum cleaner 12 (FIG. 7). The opening is preferably substantially centered in the upper wall 22 of the vacuum bag 10, although the opening can be disposed in any suitable location of the vacuum bag 10.

The collar 14 is connected to the porous container 18. The collar 14 is attached to the upper wall 22 of the container portion 18 of the vacuum bag 10, as shown in FIGS. 1-7, in communication with the opening in the upper wall. In other words, the collar 14 is attached to a side of the vacuum bag 10 in which the opening is disposed. Although the collar 14 is shown attached to the upper wall 22 of the vacuum bag 10, the opening can be disposed in the collar 14, and the collar 14 can be attached to any suitable side of the vacuum bag 10. In other words, the collar 14 can be connected to the side walls 20 of the vacuum bag 10, such that the vacuum bag 10 does not have the upper wall 22 and the ends of the side walls 18 connected to the collar 14 define the opening in the vacuum bag 10. The collar 14 can be attached to the upper wall 22 in any suitable manner, such as, but not limited to, by an adhesive or thermal welding.

The collar 14 includes an opening 14A in communication with an interior 28 of the porous container 18 of the vacuum bag 10, as shown in FIGS. 5 and 6. The collar opening 14A is configured to be aligned with and in communication with the opening in the container portion 18 of the vacuum bag 10 such that the opening 14A provides access to and is in communication with the interior 28 of the porous container 18 of the vacuum bag 10. The collar 14 has an outer surface 14B and an inner surface 14C. The outer surface 14B is configured to face a vacuum cleaner body 26 when the vacuum bag 10 is connected to the vacuum cleaner assembly 12. The inner surface 14C is configured to be attached to the upper wall 22 of the container portion 18 of the vacuum bag 10. In other words, the porous container 18 is connected to the inner surface 14C of the collar 14. The opening 14A extends completely through the collar 14 from the outer surface 14B to the inner surface 14C.

As shown in FIG. 1, the collar 14 has an insertion end 14D and an oppositely disposed non-insertion end 14E. The collar 14 is configured such that the collar 14 is connected to an attachment assembly 30 of a vacuum cleaner body of the vacuum cleaner assembly 12 in an insertion direction 32 in which the insertion end 14D of the collar 14 is removably received by the attachment assembly 30.

At least one retention member 16 is connected to the collar 14 of the vacuum bag 10, as shown in FIGS. 1-3, 5 and 6. The at least one retention member 16 is preferably connected to the outer surface 14B of the collar 14. Although the collar 14 is shown with one retention member 16, any suitable number of retention members 16 can be connected to the collar 14. The retention member 16 is spaced from the opening 14A. The retention member 16 is spaced from an outer edge 14F of the collar 14. The outer edge 14F defines the outer perimeter of the collar 14. The retention member 16 is disposed between the opening 14A and the non-insertion end 14E of the collar 14 in the insertion direction 32 of the vacuum bag 10. The retention member 16 is disposed closer to the non-insertion, or second, end 14E then to the insertion, or first, end 14D, as shown in FIGS. 1-4.

The retention member 16 can extend outwardly from the outer surface 14B of the collar 14, as shown in FIG. 5, can be flush with the outer surface 14B of the collar, or can be recessed with respect to the outer surface 14B of the collar. The retention member 16 is connected to the collar 14 in any suitable manner, such as, but not limited to, with an adhesive, by rivets, or sandwiched between layers of a multi-layer collar. The retention member 16 is a magnet or a ferromagnetic material. The retention member 16 is preferably a permanent magnet.

The attachment assembly 30 includes a base member 34 and an attachment member 36, as shown in FIGS. 1-7. The attachment member 36 is movably connected to the base member 34. Preferably, the attachment member 36 is pivotably connected to the base member 34.

The base member 34 is preferably substantially planar, as shown in FIGS. 1-7. The base member 34 has an outer surface 34A facing the attachment member 36 and an inner surface 34B configured to be connected to the vacuum cleaner body 26, as shown in FIG. 7. An opening 34C extends through the base member 34 from the inner surface 34B to the outer surface 34A, as shown in FIG. 4. A nozzle 24 is formed on the outer surface 34A of the base member 34 surrounding the opening 34C. The opening 34C extends from the inner surface 34B of the base member 34 to a free end of the nozzle 24. The base member 34 is made of any suitable material, such as a plastic.

At least one retention member 38 is connected to the attachment assembly 30, as shown in FIGS. 4-7. The at least one retention member 38 is connected to the outer surface 34A of the base member 34. The at least one retention member 38 is preferably connected to the outer surface 34A of the base member 34 of the attachment assembly 30. Although the base member 34 is shown with one retention member 38, any suitable number of retention members 38 can be connected to the base member 34. The retention member 38 is spaced from the opening 34C in the base member 34. The retention member 38 is disposed between the opening 34C and a non-hinged end 34D of the base member 34. In other words, the retention member 38 is spaced from an outer edge 34E of the base member 34. The outer edge 34E defines the outer perimeter of the base member 34. The retention member 38 extends outwardly from the outer surface 34A of the base member 34, as shown in FIGS. 5-7. The retention member 38 is connected to the base member 34 in any suitable manner, such as, but not limited to, with an adhesive or by rivets. Preferably, the number of retention members 38 connected to the base member 34 is the same as the number of retention members 16 connected to the collar 14. The retention member 38 is a magnet or a ferromagnetic material. The retention member 38 is preferably a permanent magnet.

A pair of tabs 40 extend outwardly from the outer surface 34A of the base member, as shown in FIGS. 1-7. The tabs 40 are preferably integrally formed with the base member 34 as a one-piece member.

The attachment member 36 includes an attachment portion 42 and a pair of guide rails 44 extending outwardly therefrom, as shown in FIGS. 1-7. The attachment member 36 is configured to removably receive the vacuum bag 10. The attachment portion 42 is preferably integrally formed as a one-piece member. The attachment member 36 is made of any suitable material, such as a plastic.

The attachment portion 42 includes a pair of outwardly extending projections 42A, as shown in FIGS. 1-6. The projections 42A extend in a direction substantially perpendicular to a direction in which the guide rails 44 extend. Each projection 42A is configured to be received by a tab 40 of the base member 34 to facilitate pivotal movement of the attachment member 36 relative to the base member 34.

Each of the guide rails 44 includes a slot 44A configured to removably receive the collar 14 of the vacuum bag 10, as shown in FIGS. 1 and 2. The slots 44A extend from the attachment portion 42 to an end of the guide rails 44, as shown in FIG. 1. Alternatively, a slot can be formed in the attachment portion 42 to facilitate increasing an insertion depth of the collar 14. The slot in the attachment portion 42 is substantially perpendicular to the slots 44A in the guide rails 44.

As shown in FIGS. 2-7, the insertion end 14D of the collar 14 is inserted in the slots 44A in the guide rails 44 of the attachment member 36 in the insertion direction 32. The collar 14 is inserted until the insertion end 14D of the collar 14 contacts an end of the slots 44A. The outer surface 14B of the collar 14 faces the outer surface 34A of the base member 34 of the attachment assembly 30 when the vacuum bag 10 is connected to the attachment assembly 30, as shown in FIGS. 5-7. The collar 14 has an insertion, or first, end 14D received by the slot 44A and a non-insertion, or second, end 14E spaced from the slot 44A in the insertion direction 32 of the collar 14, as shown in FIGS. 1-5. The retention member 16 of the collar 14 is disposed closer to the non-insertion, or second, end 14E then to the insertion, or first, end 14D in the insertion direction 32.

Upon removably connecting the collar 14 of the vacuum bag 10 to the attachment member 36, the attachment member 36 is pivoted with respect to the base member 34 to engage the retention member 16 of the collar 14 with the retention member 38 of the base member 34 of the attachment assembly 30, as shown in FIGS. 5-7. Each retention member 38 connected to the base member 34 is configured to be aligned with a different retention member 16 connected to the collar 14. The retention member 16 connected to the collar 14 contacts the retention member 38 connected to the base member 34, as shown in FIG. 6, to secure the collar 14 to the base member 34 of the attachment assembly 30. The attachment member 36 moves from a first open position in which the attachment assembly 30 is in an open position, as shown in FIG. 5, to a second position in which the attachment assembly 30 is in a closed position, as shown in FIG. 6. The attachment member 36 receives the collar 14 of the vacuum bag 10 in the first position in which the attachment assembly is in the open position, as shown in FIG. 5. The attachment member 36 is moved to the second position to close the attachment assembly 30, as shown in FIG. 6. The retention member 16 of the collar 14 secures the vacuum bag 10 the attachment assembly 30 of the vacuum cleaner body 26 when the attachment assembly 30 is in the closed position. The retention member 16 of the collar 14 contacts the retention member 38 of the base member 34 of the attachment assembly 30 when the attachment assembly 30 is in the closed position, as shown in FIG. 6, to secure the vacuum bag 10 to the attachment assembly 30 of the vacuum cleaner body 26 of the vacuum cleaner assembly 12.

The nozzle 24 of the attachment assembly 30 preferably protrudes through the opening 14A in the collar 14 when the attachment assembly 30 is in the closed position, as shown in FIG. 6, to form a flow path from the vacuum cleaner body 26 to the interior 28 of the vacuum bag 10, although the nozzle 24 can be substantially flush with the inner surface 14C of the collar. In other words, the nozzle 24 preferably passes through the opening 14A in the collar 14 and extends below the inner surface 14C of the collar 14 when the retention member 16 of the collar 14 contacts the retention member 38 of the base member 34 of the attachment assembly 30.

The contact between the retention members 16 and 38 securely retains the vacuum bag 10 to the vacuum cleaner body 26 during operation of the vacuum cleaner assembly 12. At least one of the retention members 16 and 38 is a magnet to magnetically attract the other of the retention members 16 and 38 to secure the vacuum bag 10 to the attachment assembly 30 of the vacuum cleaner body 26.

To remove a used vacuum bag 10, the attachment member 36 is pivoted away from the base member 34 with sufficient force to overcome the magnetic force between the retention members 16 and 38. Upon pivoting the attachment member 36 to the second position, as shown in FIGS. 2-5, the collar 14 can be slid out from the rails 44 such that a new vacuum bag 10 can be connected to the attachment assembly 30.

The vacuum cleaner body 26 includes a housing 46 that receives the vacuum bag 10, as shown in FIG. 7. The housing 46 is preferably porous to allow air passing through the vacuum bag 10 to pass through the housing 46. The housing 46 has a first housing part 48 and a second housing part 50. The first housing part 48 is secured to the vacuum cleaner body 26 of the vacuum cleaner assembly 12, as shown in FIG. 7. The vacuum nozzle 24 has an opening disposed within the housing 46 to which the vacuum bag 10 is connected such that the vacuum bag 10 is in fluid communication with the nozzle 24 of the vacuum cleaner body 26 of the vacuum cleaner assembly 12. The second housing part 50 is movably connected to the first housing part 48, such as with a hinge. The remaining portion of the second housing part 50 is connected to the first housing part 48 in any suitable manner, such as with a zipper, to enclose the vacuum bag 10 within the closed housing 46. The second housing part 50 is openable with respect to the first housing part 48, to facilitate installing and removing the vacuum bag 10.

Although the vacuum cleaner assembly 12 is illustrated in FIG. 7 as a flow-through motor-style vacuum cleaner assembly, the vacuum bag 12 and the attachment assembly 30 are applicable to any style vacuum cleaner using a vacuum bag 10.

Alternatively, one of the retention member 16 of the collar 14 and the retention member 38 of the attachment assembly 30 can be a ferromagnetic material and the other of the retention member 16 of the collar 14 and the retention member 38 of the attachment assembly 30 is a permanent magnet. In other words, either the retention member 16 of the collar 14 or the retention member 38 of the attachment assembly 30 includes a ferromagnetic material, and the other of the retention member 16 of the collar 14 and the retention member 38 of the attachment assembly 30 includes a magnet that attracts the ferromagnetic material. Preferably, the retention member 16 of the collar 14 includes a ferromagnetic material in lieu of a magnet and the retention member 38 of the attachment assembly 30 includes a magnet. The ferromagnetic material is connected to either the collar 14 or the attachment assembly similarly to the connection of the magnet.

Alternatively, the retention members 16 and 38 include a hook and loop fastening system. The retention member 16 of the collar 14 of the vacuum bag 10 can include a loop portion and the retention member 38 of the attachment assembly 30 can include a hook portion. The hook portion of the attachment assembly 30 of the vacuum cleaner body 26 securely retains the loop portion of the collar 14 of the vacuum bag 10 during operation of the vacuum cleaner assembly 26. The hook and loop system allows the vacuum bag 10 to be easily removed from the vacuum cleaner assembly and allows a new vacuum bag 10 to be connected to the vacuum cleaner assembly 26.

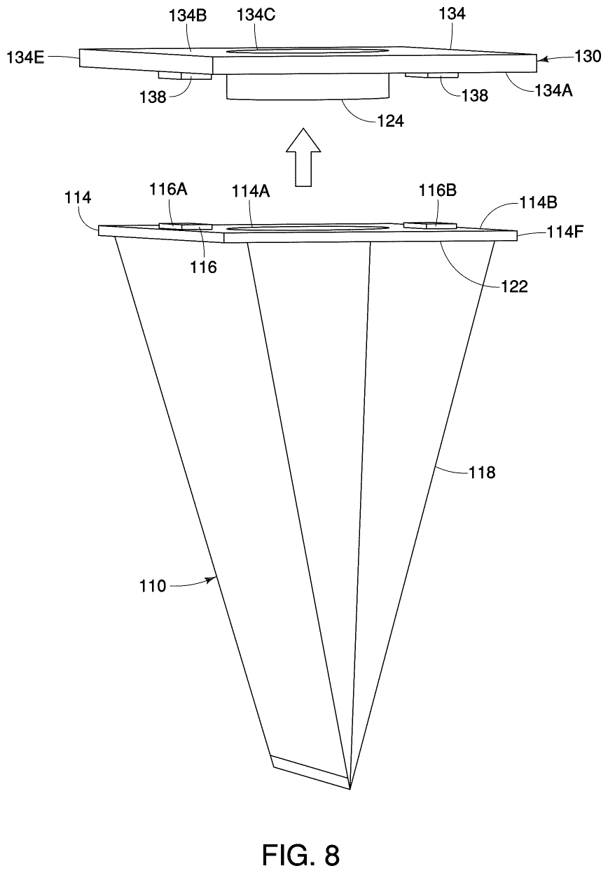

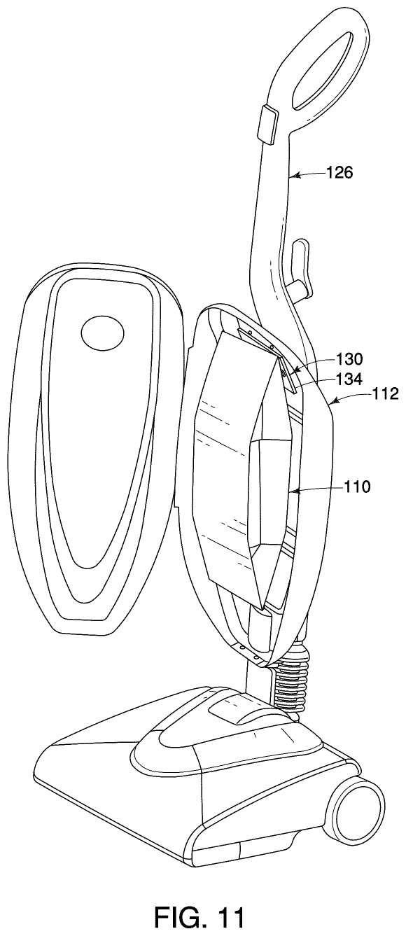

As shown in FIGS. 8-11, a vacuum cleaner assembly 112 in accordance with another illustrated exemplary embodiment is substantially similar to the vacuum cleaner assembly 12 of the exemplary embodiments illustrated in FIGS. 1-7 except for the differences described below. Similar parts are identified with similar reference numerals, except increased by 100 (i.e., 1xx, accordingly), as appropriate.

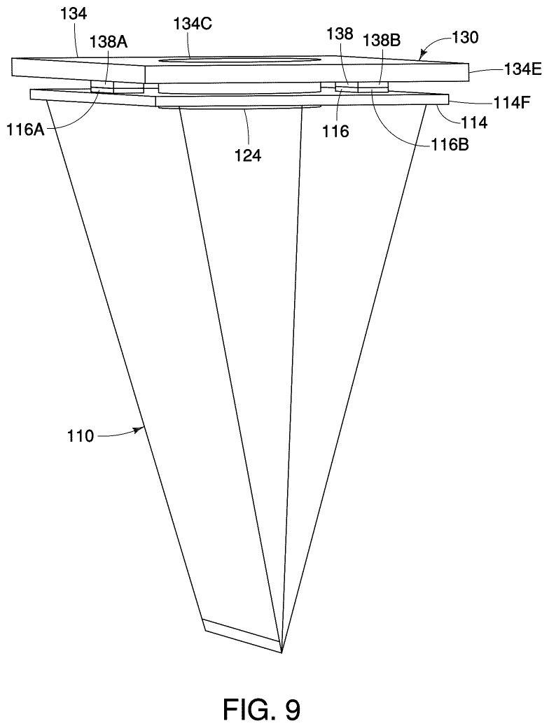

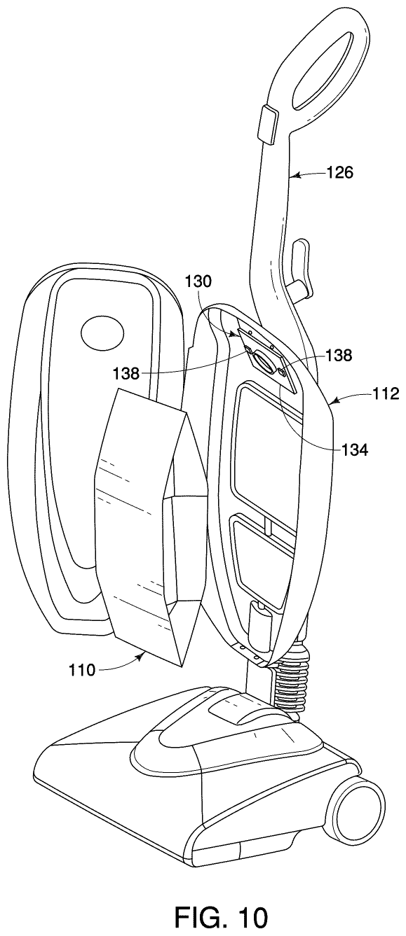

A vacuum bag 110 includes a collar 114, as shown in FIGS. 8-9. The collar 114 has an outer surface 114B and an inner surface 141C. The outer surface 114B is configured to face a vacuum cleaner body 126 when the vacuum bag 110 is connected to the attachment assembly 130 of the vacuum cleaner body 126 of the vacuum cleaner assembly 112. The inner surface 114C of the collar 114 is configured to be attached to the upper wall 122 of the container portion 118 of the vacuum bag 110. An opening 114A extends completely through the collar 114 from the outer surface 114B to the inner surface 114B.

The collar 114 has a plurality of retention members 116 connected to the outer surface 114B, as shown in FIGS. 8-9. Although the vacuum bag 110 is illustrated with two retention members 116, any suitable number of retention members 116 can be used. The retention members 116 are disposed on opposite sides of the collar opening 114A. A first retention member 116A and a second retention member 116B are connected to the outer surface 114B of the collar 114. The first retention member 116A is diametrically opposed to the second retention member 116B with respect to the opening 114A. Each of the first and second retention members 116A and 116B is spaced from an outer edge 114F of the collar 114. The outer edge 114F defines the outer perimeter of the collar 114. Each of the first and second retention members 116A and 116B can extend outwardly from the outer surface 114B of the collar 114, as shown in FIG. 8. Alternatively, each of the first and second retention members 116A and 116B can be flush with the outer surface 114B of the collar, or can be recessed with respect to the outer surface 14B of the collar 114.

The retention members 116 are connected to the collar 114 of the vacuum bag 110, as shown in FIGS. 8 and 9. The retention members 116 are preferably connected to the outer surface 114B of the collar 114. The retention members 116 are spaced from the opening 114A. The retention members 116 are diametrically opposed relative to the opening 114A. The retention members 116 are connected to the collar 114 in any suitable manner. Each of the retention members 116 is a magnet or a ferromagnetic material. Each of the retention members 116 is preferably a permanent magnet.

The attachment assembly 130 includes a base member 134, as shown in FIGS. 8-10. The base member 134 is preferably substantially planar. The base member 134 has an outer surface 134A configured to face the vacuum bag 110 and an inner surface 134B configured to be connected to the vacuum body 126, as shown in FIGS. 9 and 10. An opening 134C extends through the base member 134 from the inner surface 134B to the outer surface 134A. A nozzle 124 is formed on the outer surface 134A of the base member 134 surrounding the opening 134C. The opening 134C extends from the inner surface 134B of the base member 134 to a free end of the nozzle 124. The base member 134 is made of any suitable material, such as a plastic.

The retention members 138 are connected to the outer surface 134A of the base member 134 of the attachment assembly 130, as shown in FIGS. 8-10. The retention members 138 are preferably connected to the outer surface 134A of the base member 134 of the attachment assembly 130. Although the base member 134 is shown with two retention members 138, any suitable number of retention members 138 can be connected to the base member 134.

The retention members 138 are spaced from the opening 134C in the base member 134, as shown in FIGS. 8 and 9. The retention members 138 are diametrically opposed relative to the opening 134C. Each of the retention members 138 is spaced from an outer edge 134E of the collar 114. The outer edge 134E defines the outer perimeter of the base member 134. Each of the retention members 138 extends outwardly from the outer surface 134A of the base member 134.

The retention members 138 are connected to the base member 134 in any suitable manner. Preferably, the number of retention members 138 connected to the base member 134 is the same as the number of retention members 116 connected to the collar 114. Each of the retention members 138 is preferably a permanent magnet.

As shown in FIGS. 8-11, the outer surface 114B of the collar 114 is brought into contact with the outer surface 134A of the base member 134 of the attachment assembly 130. Each retention member 138 connected to the base member 34 is configured to be aligned with one of the retention members 116 connected to the collar 114. Each of the retention members 116 connected to the collar 114 contacts a different one of the retention members connected to the base member 134, as shown in FIG. 9, to secure the collar 114 to the base member 134 of the attachment assembly 130. In other words, the first retention member 116A of the collar 114 engages the first retention member 138A of the base member 134, and the second retention member 116B of the collar 114 engages the second retention member 138B of the base member 134. The retention members 116 of the collar 114 secure the vacuum bag 110 to the attachment assembly 130 of the vacuum cleaner body 126. The nozzle 124 of the attachment assembly 130 preferably protrudes through the opening 114A in the collar 14 when the when the vacuum bag 110 is properly connected to the attachment assembly 130 of the vacuum cleaner assembly 112, as shown in FIG. 9, to form a flow path from the vacuum cleaner body 114 to the vacuum bag 110, although the nozzle 124 can be substantially flush with the inner surface 114C of the collar. In other words, the nozzle 124 preferably passes through the opening 114A in the collar 114 and extends below the inner surface 114C of the collar 114 when the retention members 116 of the collar 114 contact the retention members 138 of the base member 134 of the attachment assembly 130, as shown in FIG. 9.

The contact between the retention members 116 and 138 securely retains the vacuum bag 110 to the vacuum cleaner body 126 during operation of the vacuum cleaner assembly 112. To remove a used vacuum bag 110, the vacuum bag 110 is pulled away from the base member 134 with sufficient force to overcome the magnetic force between the retention members 116 and 138. A new vacuum bag 110 can then be connected to the attachment assembly 130.

Alternatively, one of the retention member 116 of the collar 114 and the retention member 138 of the attachment assembly 130 can be a ferromagnetic material and the other of the retention member 116 of the collar 114 and the retention member 138 of the attachment assembly 130 is a permanent magnet. In other words, either the retention member 116 of the collar 114 or the retention member 138 of the attachment assembly 130 includes a ferromagnetic material, and the other of the retention member 116 of the collar 114 and the retention member 138 of the attachment assembly 130 includes a magnet that attracts the ferromagnetic material. Preferably, the retention member 116 of the collar 114 includes a ferromagnetic material in lieu of a magnet and the retention member 138 of the attachment assembly 130 includes a magnet. The ferromagnetic material is connected to either the collar 114 or the attachment assembly similarly to the connection of the magnet.

The foregoing detailed description of the certain exemplary embodiments has been provided for the purpose of explaining the principles of the invention and its practical application, thereby enabling others skilled in the art to understand the invention for various exemplary embodiments and with various modifications as are suited to the particular use contemplated. This description is not necessarily intended to be exhaustive or to limit the invention to the exemplary embodiments disclosed. Any of the exemplary embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “forward”, “rearward”, “front”, “rear”, “up”, “down”, “above”, “upper”, “below”, “lower”, “upward”, “upwardly”, “downward”, “downwardly”, “top”, “bottom”, “side”, “vertical”, “horizontal”, “perpendicular” and “transverse” as well as any other similar directional terms refer to those directions of a vacuum cleaner assembly in an upright position for use. Accordingly, these directional terms, as utilized to describe the vacuum cleaner assembly should be interpreted relative to a vacuum cleaner in an upright position on a horizontal surface. The terms “left” and “right” are used to indicate the “right” when referencing from the right side as viewed from the rear of the vacuum cleaner assembly, and the “left” when referencing from the left side as viewed from the rear of the vacuum cleaner assembly.

Also, it will be understood that although the terms “first” and “second” may be used herein to describe various components, these components should not be limited by these terms. These terms are only used to distinguish one component from another. Thus, for example, a first component discussed above could be termed a second component and vice versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the exemplary embodiments according to the present invention are provided for illustration only, and not for the purpose of limiting the invention as defined by the appended claims and their equivalents.

What is claimed is:

1. A vacuum bag for a vacuum cleaner assembly, comprising:
a porous container,
a collar connected to the porous container, the collar including an opening in communication with an interior of the porous container; and
a first retention member connected to the collar, the first retention member being a magnet or a ferromagnetic material.

2. The vacuum bag according to claim 1, wherein
the collar has an outer surface and an inner surface, the first retention member being disposed on the outer surface of the collar.

3. The vacuum bag according to claim 2, wherein
an opening is disposed in the collar, the opening extending from the inner surface to the outer surface of the collar.

4. The vacuum bag according to claim 3, wherein
the porous container is connected to the inner surface of the collar.

5. The vacuum bag according to claim 3, wherein
a second retention member is connected to the outer surface of the collar.

6. The vacuum bag according to claim 5, wherein
the first retention member is diametrically opposed to the second retention member with respect to the opening.

7. The vacuum bag according to claim 1, wherein
the first retention member is spaced from an outer edge of the collar.

8. The vacuum bag according to claim 5, wherein
each of the first and second retention members is spaced from an outer edge of the collar.

9. The vacuum bag according to claim 1, wherein
the first retention extends outwardly from the outer surface of the collar.

10. The vacuum bag according to claim 5, wherein
each of the first and second retention members extends outwardly from the outer surface of the collar.

11. A vacuum cleaner assembly, comprising:
a vacuum cleaner body including
an attachment assembly including a first retention member connected thereto; and
a vacuum bag removably connected to the attachment assembly, the vacuum bag including
a porous container;
a collar connected to the porous container; and
a second retention member connected to the collar,
the second retention member being configured to contact the first retention member to secure the vacuum bag to the attachment assembly of the vacuum cleaner body, and
the first retention member being one of a magnet and a ferromagnetic material, and the second retention member being one of a magnet and a ferromagnetic material, at least one of the first retention member and the second retention member being a magnet to magnetically attract the other of the first retention member and the second retention member to secure the vacuum bag to the attachment assembly of the vacuum cleaner body.

12. The vacuum cleaner assembly according to claim 11, wherein
the attachment assembly includes a base member and an attachment member, the attachment member being pivotally connected to the base member, and the first retention member being connected to the base member,
the base member being connected to the vacuum cleaner body, and the attachment member removably receiving the vacuum bag.

13. The vacuum cleaner assembly according to claim 12, wherein
the first retention member is disposed on an outer surface of the base member of the attachment assembly, and
the second retention member is disposed on an outer surface of the collar,
the outer surface of the collar facing the outer surface of the base member of the attachment assembly when the vacuum bag is connected to the attachment assembly.

14. The vacuum cleaner assembly according to claim 13, wherein
upon removably connecting the vacuum bag to the attachment member, the attachment member is pivoted with respect to the base member to engage the second retention member with the first retention member.

15. The vacuum cleaner assembly according to claim 14, wherein
the attachment member is movable between a first position in which the second retention member is not engaged with the first retention member, and a second position in which the second retention member engages the first retention member.

16. The vacuum cleaner assembly according to claim 12, wherein
the first retention member is spaced from an outer edge of the base member, and
the second retention member is spaced from an outer edge of the collar.

17. The vacuum cleaner assembly according to claim 12, wherein
the attachment member includes a slot to removably receive the vacuum bag.

18. The vacuum cleaner assembly according to claim 17, wherein
the collar has a first end received by the slot and a second end spaced from the slot in an insertion direction of the collar, the second retention member being disposed closer to the second end then to the first end in the insertion direction.

19. The vacuum cleaner assembly according to claim 12, wherein
the attachment assembly includes a base member, and a nozzle extending outwardly from the base member,
the first retention member being connected to the base member, and the vacuum bag being removably connected to the base member.

20. The vacuum cleaner assembly according to claim 11, wherein
an opening is disposed in the collar, the opening extends from the inner surface to the outer surface of the collar, and the second retention member is spaced from the opening.
